(19) United States
(12) Patent Application Publication
(10) Pub. No.: US 2024/0338602 A1
(43) Pub. Date: Oct. 10, 2024

(54) Training a Learning Model using a Digital Twin

(71) Applicant: PassiveLogic, Inc., Holladay, UT (US)

(72) Inventors: Troy Aaron Harvey, Holladay, UT (US); Porter Jonas Child, Holladay, UT (US)

(73) Assignee: PassiveLogic, Inc., Holladay, UT (US)

(21) Appl. No.: 18/628,647

(22) Filed: Apr. 5, 2024

Related U.S. Application Data
(60) Provisional application No. 63/457,618, filed on Apr. 6, 2023.

(51) Int. Cl. G06N 20/00

(52) U.S. Cl. CPC G06N 20/00

(57) ABSTRACT

Various embodiments are described herein relating to a method, system, and non-transitory machine readable storage medium for training a learning model using a digital twin model, the method includes: a learning model interfacing with the digital twin model within an iterated digital twin system. For each iteration of the iterated digital twin system, one or more of the following steps may occur: generating digital twin input using an optimization process; running the digital twin model using the digital twin input, producing digital twin output; running the learning model using the digital twin input, producing learning model output; using the digital twin output as learning model ground truth and learning model output in a learning model cost function; and using a cost derived from the learning model cost function to backpropagate through the learning model as a part of improving values of parameters of the learning model.

### FIELD OF INVENTION

The present disclosure relates to optimization techniques and more specifically, but not exclusively, to techniques for using a digital twin to train a learning model.

### SUMMARY

This summary is provided to introduce a selection of concepts in a simplified form that are further described below in the Detailed Description section. This summary does not identify required or essential features of the claimed subject matter. The innovation is defined with claims, and to the extent this Summary conflicts with the claims, the claims should prevail.

In embodiments, a method of training a learning model using a digital twin is disclosed, the method including: a learning model interfacing with a digital twin within an iterated digital twin system: for each iteration of the iterated digital twin system: generating digital twin input using an optimization process running the digital twin using the digital twin input, producing digital twin output; running the learning model using the digital twin input, producing learning model output; using the digital twin output as learning model ground truth and learning model output in a learning model cost function; and using a cost derived from the learning model cost function to backpropagate through the learning model as a part of improving values of parameters of the learning model.

Embodiments further include generating new digital twin input using the optimization process, running the learning model using the new input, producing learning model output; running the digital twin using the new input, producing digital twin output; and comparing the learning model output and the digital twin output to determine learning model divergence from the digital twin.

In embodiments, when the learning model divergence from the digital twin is greater than a predetermined value then performing at least one iteration of the iterated digital twin system.

Various embodiments further include a digital twin ground truth. These embodiments may also include using the cost derived from the learning model output and the digital twin ground truth to determine when a learning model stopping state has been reached; and when the learning model stopping state has been reached, then running the learning model without running the digital twin.

In embodiments, the learning model's approximation of the the digital twin input space is more convex than the digital twin's input space.

In embodiments, the learning model is a recurrent neural network.

In embodiments, the recurrent neural network uses a ReLu as its activation function.

In embodiments, the digital twin is a heterogenous neural network.

In embodiments, the digital twin has input nodes and output nodes, the learning model has input nodes and output nodes, and there is an equal number of digital twin input nodes and learning model input nodes; and wherein there is an equal number of digital twin output nodes and learning model output nodes.

In embodiments, a learning model training system is disclosed. It may include: a processor; a memory in operable communication with the processor; a learning model interfacing with a digital twin within an iterated digital twin system; a digital twin input generator that generates digital twin input using a optimization process; a digital twin runner that runs the digital twin using the digital twin input, producing digital twin output; a learning model runner that runs the learning model using the digital twin input, producing learning model output; a cost function determiner that uses the digital twin output as learning model ground truth which it compares to the learning model output producing a cost; and a backpropagator which uses the cost to backpropagate through the learning model as a part of improving values of parameters of the learning model.

Various embodiments include running the learning model using new input from the digital twin input generator, producing learning model output; running the digital twin using the new input, producing digital twin output; and comparing the learning model output and the digital twin output to determine learning model divergence from the digital twin.

Various embodiments include an iterator, such that for each iteration, input of the digital twin runner is used as input into the learning model.

In embodiments, when the learning model stopping state has been reached, then the learning model is run without running the digital twin.

In embodiments, when the learning model divergence is greater than a threshold amount, then running the learning model within the iterated digital twin system.

In embodiments, a non-transient storage medium configured with code is disclosed, the code which upon execution by one or more processors performs a method of training a learning model using a digital twin, the method including one or more of the following: for each iteration of an iterated digital twin system: generating digital twin input using an optimization process; running the digital twin using the digital twin input, producing digital twin output; running the learning model using the digital twin input, producing learning model output; using the digital twin output as learning model ground truth and learning model output in a learning model cost function; and using a cost derived from the learning model cost function to backpropagate through the learning model as a part of improving values of parameters of the learning model.

### BRIEF DESCRIPTION OF THE FIGURES

In order to better understand various example embodiments, reference is made to the accompanying drawings, wherein:

FIG. 1 illustrates an example of a relationship between inputs and outputs of a simulator and a learning model during a training process;

FIG. 2 illustrates an example of a computing system;

FIG. 3 illustrates an example of a distributed computing system;

FIG. 4 illustrates an example of a method describing a high level method to train a learning model using a simulator;

FIG. 5 illustrates an example of a method describing a method to train a learning model using a simulator;

FIG. 6 illustrates an example of a method describing a method to test a learning model using a simulator;

FIG. 7 illustrates examples of inputs and outputs of learning models and digital twins;

FIG. 8 illustrates examples of correlations between cost functions for a learning model and cost functions for a digital twin;

FIG. 9 illustrates an example of a learning model training system;

FIG. 10 illustrates examples of more convex and less convex functions;

FIG. 11 illustrates examples of possible uses for embodiment disclosed herein;

FIG. 12 illustrates examples of possible inputs which may be used with embodiments disclosed herein;

FIG. 13 illustrates examples of possible outputs which may be used with embodiments disclosed herein;

FIG. 14 illustrates examples of possible objects which may be modified using embodiments disclosed herein;

FIG. 15A discloses a method to use a learning model to provide starting values to a digital twin value.

FIG. 15B discloses an example of a learning model running separately.

FIG. 15C discloses an example of a digital twin running separately.

FIG. 16A discloses certain possible relationships between a controlled space, a digital twin, and a learning model;

FIG. 16B discloses certain possible relationships between a controlled space and multiple digital twins;

FIG. 17 discloses certain possible relationships between a digital twin and multiple learning models;

FIG. 18 discloses certain possible relationships between a digital twin and a library of training examples;

FIG. 19 discloses certain possible relationships between a library of training examples and learning models;

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or” refers to a non-exclusive “of” (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

“Optimize” means to improve, not necessarily to perfect. For example, it may be possible to make further improvements in a value or an algorithm which has been optimized.

A “cost function,” generally, is a function determines how close an output a digital twin, optimization model, or other algorithm is to the desired output in some cases, the desired output is a ground truth the algorithm is intended to predict, simulate, or otherwise provide. That is, in various embodiments, a cost function quantifies the error between the predicted value and the desired value. This cost function returns a cost. The cost function may use a least squares function, a Mean Error (ME), Mean Squared Error (MSE), Mean Absolute Error (MAE), a Categorical Cross Entropy Cost Function, a Binary Cross Entropy Cost Function, and so on, to arrive at the answer. In some implementations, the cost function is a loss function. In some implementations, the cost function is a threshold, which may be a single number that indicates the simulated truth curve is close enough to the ground truth. In other implementations, the cost function may be a slope. The slope may also indicate that the simulated truth curve and the ground truth are of sufficient closeness. When a cost function is used, it may be time variant. It also may be linked to factors such as user preference, or changes in the physical model. The cost function applied to the digital twin engine may include models of any one or more of the following: energy use, primary energy use, energy monetary cost, human comfort, the safety of building or building contents, the durability of building or building contents, microorganism growth potential, system equipment durability, system equipment longevity, environmental impact, and/or energy use CO2 potential. The cost function may utilize a discount function based on discounted future value of a cost. In some embodiments, the discount function may devalue future energy as compared to current energy such that future uncertainty is accounted for, to ensure optimized operation over time. The discount function may devalue the future cost function of the control regimes, based on the accuracy or probability of the predicted weather data and/or on the value of the energy source on a utility pricing schedule, or the like. A cost may be derived from a cost function This cost may be a single number. A “goal function” may read in a cost (a value from a cost function) and determine if that cost meets criteria such that a goal has been reached, such that the digital twin iterations stop. Such criteria may be the cost reaching a certain value, being higher or lower than a certain value, being between two values, etc. A goal function may also look at the time spent running the digital twin overall and/or how may iterations have been made to determine if the goal function has been met.

An “optimization algorithm” or “optimization method” may be used to determine a set of inputs used to run a digital twin. These optimization algorithms or optimization methods may include Gradient Descent, methods based on Newton's method, and inversions of the Hessian using conjugate gradient techniques, Evolutionary computation such as Swarm Intelligence, Bee Colony optimization; self-organizing migrating algorithm (SOMA), Particle Swarm, Non-linear optimization techniques, and other methods known by those of skill in the art.

A “state” as used herein may be Air Temperature, Radiant Temperature, Atmospheric Pressure, Sound Pressure, Occupancy Amount, Indoor Air Quality, CO2 concentration, Light Intensity, or any other state that can be measured and controlled. Various embodiments described herein relate particularly to control of heating, ventilation, and air conditioning (HVAC) control; it will be appreciated that the methods herein may be adapted and applied to various other domains such as, for example, lighting, agriculture, irrigation, industrial, manufacturing, refinery, power, and other control. The types of “state” that may be monitoring and controlled in such systems will be apparent to those of skill in the art.

The digital twins described herein may include a a digital twin which, in turn, may include deep physics networks. These deep physics networks may be a type of structured similar to neural networks. In some such embodiments, unlike the homogeneous activation functions of more traditional neural nets, each neuron includes unique physical equations (for the equipment model) or resistance/capacitance values (for the building model). Such automated models can then be used for real-time sequence generation and fault detection. To automate a structure, the digital twin may represent the structure. The digital twin may include a set of interconnected nodes (which may also be referred to as “neurons”). In such a digital twin, each node may represent the components of a building structure such as, for example, rooms/zones, walls, windows, sensors, etc. These nodes may include physics-based activation functions that describe the ideal flow of state through the building or other environment being simulated. For example, in the context of heat, the activation functions may model the transfer of heat from a room to a wall having particular characteristics (e.g., material and thickness) and vice versa. Using such a digital twin, the propagation of heat (or other state) can be simulated through the building (or other environment).

The digital twin may also represent equipment in the system (the equipment digital twin). This equipment model may include nodes that represent equipment, their connections, and outside influences on the equipment, such as weather. For example, in the context of an HVAC system, the nodes may represent equipment such as boilers, valves, heat exchangers, radiators, heating coils, fans, etc. These nodes in the equipment model may include activation functions based on physics equations or other formulae that describe equipment state change. For example, a boiler may be described by a function indicating internal temperature of fluid over time after activation. Equipment nodes may also have state input(s) and state output(s), state parameters with values, allowable state parameter values, state input location data, and state output location data. The location data can be cross-referenced to the thermodynamic building model locations. In embodiments, the equipment nodes may form control loops. These nodes inputs and outputs along along with the connections between the equipment form a heterogenous neural network. Accordingly, state “flows” through the digital twin models following physical rules encapsulated in the activation functions.

In various embodiments, activation functions may be statically set to the corresponding physical functions. In some embodiments, while activation functions may initially be set according to the physical functions, the model may adjust the functions, variables associated with the functions, or weights applied thereto according to some optimization method (e.g., gradient descent or other optimization methods) as feedback is received from the system being modeled by the digital twin (e.g., the building or HVAC equipment system). In this way, while the activation functions remain based on the physics formulae, the digital twin may adapt at least some of its neurons from the ideal version to a version that better simulates the specific non-ideal, real-world implementations that the digital twin models.

Conceptually, running a structure digital twin my include inserting some amount of some measurable state into the simulated building. This can be temperature, humidity, acoustic, vibration, magnetic, light, pressure, moisture, etc. This state then propagates through the different layers, affecting the structure. This illustrative example uses temperature to describe aspects of the system and methods (brick, insulation, drywall, etc.) heating up rooms, as represented by inside nodes. An outside node is associated with a time heat curve T. The curve value at time Ti is injected into one or more outside nodes. This temperature is propagated through the building (by the values of the nodes of the digital twin neural nets). The outside of the building (say, brick), has its temperature modified by the outside node and known aspects of how heat transfers through brick as found in the brick node. The brick then heats up the next layer, perhaps insulation. This continues throughout the building until an inside node is reached. At inside nodes, other functions can be applied, such as those that represent lighting and people (warmth) within the zone. State information continues to propagate until another outside layer is reached, with individual node parameter values representing the heating present in the building at time Ti. In some embodiments, each outer surface has its own time temperature curve. In some embodiments a building is deconstructed into smaller subsystems, (or zones) so rather than propagating temperature through the entire structure, only a portion of the structure is affected by a given input. In some implementations, the digital twin models are built on a controller that is associated with the building being controlled. In some instances, the controller is embedded in the controlled building and is used to automate the building. A controller may include a digital twin engine that itself includes a model of the controlled system the controller is in, or a model of the equipment in the controlled system the controller is in. This model may be called the “physical model.” This physical model may itself include past regressions and a cost function. The past regressions are instances of these model being run in the past and the results. The controlled system has at least one sensor whose value can be used to calibrate the physical model(s) by checking how close the model value at the sensor location is to the simulated sensor value equivalent in the physical models. A cost function may be used to determine the distance between the sensor value and the simulated sensor value equivalent. This information can then be used to refine the physical models. This Controller-Controlled system loop may be implemented without use of the internet. The Controller may control and/or run a Local Area Network (LAN) with which it talks to sensors and other resources. The Controller may be hardwired into the sensors and other resources, or there may be a combined system, with some resources hardwired, and other resources which connect to the LAN. A “digital twin” may be a resource model a building model, a scientific equipment model, etc.

According to the foregoing, and to the further teachings in U.S. patent application Ser. Nos. 17/009,713, 17/177,285, and 18/499,073, which are hereby incorporated by reference for all purposes, a digital twin is created that is capable of running multiple digital twins for multiple different purposes. For example, in the HVAC context, the digital twin could be use to simulate the temperature over time in a first room, the temperature at a particular point in time in a second room, the humidity over time in another room, the temperature of a boiler over time, or the impact on the state across multiple room from controlling a piece of equipment (e.g., turning it on or changing a setting). In various embodiments, the digital twin may be a nondirectional digital twin, meaning that there is no defined output value as would be expected in a traditional neural network; instead, each neuron in the digital twin may track the state of a zone, device, or other unit of interest. If any particular state is of interest, it can be extracted from the neuron as needed. In other embodiments, while the digital twin may provide a defined output, values may also be read from intermediate nodes. Such a digital twin, while flexible and fully featured, may be particularly complex and computationally intensive. As such, it may require a large amount of time or a large amount of processing resources to obtain an answer to a question or other desired output.

Additionally, in some cases, an answer may require multiple digital twins to generate. For example, to determine an optimal control scheme, a controller might simulate the effect of many different possible control schemes using the digital twin, and select the highest performing control scheme. In some cases, selection of a control scheme (and other optimization tasks) may be performed using gradient descent on a cost function calculated from the digital twin. This may entail using the desired end point as the cost function, or a portion thereof, with many control schemes tried to meet it. For example, a simple desired cost function may involve the amount of energy used and a desired temperature. However, the complexity of the digital twin may translate to a complex cost function with multiple local minima that may pose a challenge for gradient descent.

To address these challenges, various embodiments disclosed herein leverage the digital twin to train one or more secondary “learning” models for a particular purpose. For example, while as explained above the digital twin may be used to simulate many different values of different types and uses, one or more learning models may be trained to simulate a specific item, such as the temperature in one room or the temperature curves over multiple rooms. Thereafter, the learning model may be used instead of the full digital twin in those cases where the learning model is relevant. Additionally, the learning model may serve as a “first run.” For example, candidate control schemes may be selected or filtered using one or more learning models first, and then tested on the digital twin (thereby reducing the number of control schemes that are simulated on the full digital twin). Alternatively, the cost function of the learning model may be less complex and less likely to produce troublesome local minima for gradient descent to identify an initial set of controls. Thereafter, that initial set of controls may represent a better starting point for gradient descent on the full model to locate an ideal set of controls to be implemented. Further, the learning digital twin may produce an approximate digital twin output without running a full digital twin, which may run faster, produce a reasonable approximation. The learning digital twin may be a recurrent neural network with input, hidden layers, and output, a convolutional neural network, etc. This learning may be trained by feeding the successive inputs and outputs that the full digital twin uses as it solves a given problem.

The technical character of embodiments described herein will be apparent in view of the foregoing to one of ordinary skill in the art, and will also be apparent in several ways to a wide range of attentive readers. Some embodiments address technical activities that are rooted in computing technology, such as determining more efficient ways to perform digital twins. These digital twins may simulate energy flow in a building or other structure. The energy flow digital twin may produce control sequences that allow a building to run with much more energy efficiency. As somewhere around 40% of all energy use in the United States is used in buildings, even a small reduction overall would constitute significant energy savings. The digital twins disclosed herein may be able to train learning models that, when trained, run much quicker than the original digital twin, allowing for much more complex digital twins, on the same computer hardware. This will allow for much more accurate digital twins, again, using the same computer hardware. Even when a learning model is not completely accurate, it may be able to provide a starting space for the digital twin that allows the digital twin to run much quicker, giving similar computer speed and complexity benefits. Other advantages based on the technical characteristics of the teachings will also be apparent to one of skill from the description provided.

### Overview

Digital twin systems using optimization techniques to iteratively arrive at optimal states can be developed that are very powerful. However, this power is often tempered by slow speed. On the other hand, learning models such as neural networks, once trained can run very quickly and can be very powerful at solving difficult problems. However, such models must be trained with many sets of training data before they are able to offer a reasonable solution. Acquiring sufficient training examples is often difficult, and sometimes insurmountable. Developing a training set involves acquiring and/or generating many examples of input data that can then generate meaningful output data. One way to do this is use as training data synthetic or actual examples of data from problems that the learning model is designed to solve. The learning model should preferentially be trained on real-world data, if possible, thus receiving a representative training set. When modeling buildings, however, data can only be gathered in real time; a single year-long data set takes a year to generate. Providing synthetic data produces its own sort of problems. When synthetic data is used, the learning model has a difficult time giving accurate answers to real-world data, as the real world includes examples that were not generated by the synthetic data generation procedure—the data is either overfitted (noise is misinterpreted as parameters) or underfitted (parameters are missed). This problem is so severe that “[i]t is quite common to invest days to months of time on hundreds of machines in order to solve even a single instance of the neural network training problem.” Goodfellow et al., “Deep Learning (Adaptive Computation and Machine Learning series)”, MIT Press, Nov. 18, 2016, p. 274. Another difficult to overcome problem is the large number of training sets required to generate usable solutions. As the number of parameters in a model rises, the amount of training data needed increases exponentially to achieve a state solution. The training data must also be representative of the data the model will actually encounter, or the results will be biased in a way that is difficult to ascertain. These models are also computationally intensive, such that models can require very expensive equipment to run, require very large amounts of time, and so on. This is made more difficult by the nature of real-world data-gathering. For example, as mentioned earlier, a single year-long data set for a building takes a year to accumulate. Methods, systems, and non-transitory storage media disclosed herein solve many of these problems. Digital twins (which may be heterogenous neural networks) are presented that generate input and output data that are then used in a learning model (which may be a traditional neural network) to train it. As the data is real data from a digital twin that mimics the physics presented in a real system, the training data is representative of the data the model will encounter, not biasing the model. Further, the models may run much quicker than alternatives.

We disclose here systems and methods to train a learning model by imitating a digital twin. To understand this, we must discuss some aspects of the neural networks that may be used in such a digital twin. The digital twins that are used herein may be a type of structured network similar to neural networks composed of neurons. That is, they have neurons (or nodes) connected by edges with weights. These weights are used in an activation function that produces an output which is then sent down edges to different neurons, etc. Unlike the homogeneous activation functions of most neural networks, the neurons disclosed herein have, as activation functions, different physical equations (for the some models, such as an equipment digital twin) or resistance/capacitance values (for some models, such as a structure digital twin). The neurons may represent actual structures, such as sensors and other equipment. Once a neural network has been created, data from known sensors in a real building may be fed into their corresponding nodes in the network, allowing the network to be trained on real-world data. Once the network is trained, time series generated from the models can then be used for optimization of model features, real-time equipment sequence generation and fault detection. More specifically, a matching digital twin version of the building and/or a digital twin of the equipment in the building (the equipment digital twin) be created. The structure model includes nodes that represent the individual material layers of the building and their resistance and capacitance. These are formed into parallel and branchless neural network strings that propagate heat (or other state values) through them. The equipment model includes nodes that represent equipment, their connections, and outside influences on the equipment, such as weather. Nodes may utilize physics equations in activation functions that describe equipment state change and other changes. Equipment nodes may also have state input(s) and state output(s) which may be edges with weights, state parameters with values that reside as part of an activation functions, allowable state parameter values, state input location data, and state output location data. The location data can be cross-referenced to the thermodynamic building model locations or equipment model locations. In embodiments, the equipment nodes may form control loops. These nodes inputs and outputs along with the connections between the equipment form a heterogenous neural network. State information flows through the model following physical rules.

In some embodiments, a state that can be measured (or at least determined) within a structure being modeled is chosen. In a building being modeled for HVAC control, this may be room temperature, which will be used in this embodiment. Rooms often have thermometers installed within them, and even when they do not, it is easy enough to measure temperature within a room over time. This chosen measurement (e.g., temperature) is then measured for some period of time in the rooms, giving a state-time curve. These temperature state time curves are then used as the “ground truth” for an initial value digital twin. That is, the optimizer modifies beginning values within the simulator in an attempt to match the “ground truth” (the temperature time curves within rooms in the building) throughout the digital twin. Before going further with our example, the makeup of the digital twin will be addressed. A digital twin may break down the structure being modeled into nodes. These nodes may be portions of the building that separately carry state values (temperature, humidity, etc.), such as windows, ceilings, floors, studs, and the like. The nodes may represent even smaller chunks, such as layers of building portions. For example, an inner wall may be described by nodes that represent a layer of sheetrock with specific insulation values, a layer of insulation with its own values, studs, and another layer of sheetrock, and so on. An outside wall representation may have nodes that represent the outer material, such as brick, then insulation, then sheetrock, and so on. The digital twin simulator includes these nodes, each with state values (e.g., temperature), connected, as described previously with the nature of the activation functions. These digital twins may be very accurate, as they rely on physics equations and physical characteristics embodied in activation functions of nodes representing structures and equipment. However, by nature of the physics equations embedded within, the models are almost certainly non-convex. Not only that, but they may be very very complex with thousands of non-linear functions embodied in the heterogenous activation functions. A more convex (informally) learning model, if able to be trained, could provide benefits. For example, the computer hardware may be able to run the system much more efficiently; less hardware would be needed; more complex models could be run, and so on. Even if both models have equally complex surfaces the learning model may run quicker than the training model, as the models will certainly be running in different spaces, one of which may be easier to solve.

The learning model may be a more standard neural network. This neural network may include neurons. The neurons are like individual processing units within the network. They receive input signals, process them, and generate an output signal. The neurons are organized into layers. There are typically three types of layers: the input layer that receives raw input. Hidden layers are intermediate layers between the input and output layers. They perform computations and extract features from the input data. An output layer produces the final output prediction. Neurons in adjacent layers are connected by connections, with each connection having an associated weight that represents its importance. Each neuron typically applies an activation function to the weighted sum of its inputs. Activation functions introduce non-linearity into the network, allowing it to learn complex patterns and relationships in the data. Activation functions used by the neural network may include a Rectified Linear Unit (ReLU), a Hyperbolic Tangents (Tanh), the Sigmoid Function, Leaky ReLU, Parametric ReLU, Exponential Linear Unit, etc. The process of passing input data through the layers to generate an output prediction. During forward propagation, input signals are multiplied by connection weights, summed up, and passed through activation functions to produce outputs for each neuron. The process of updating connection weights minimizes prediction error. For example, it involves calculating the gradient of the cost function with respect to the weights and adjusting the weights through optimization algorithms such as gradient descent. A cost function measures the difference between the predicted output and the actual output. During training, the goal is to minimize the cost function by adjusting the weights of the network. Overall, a neural network learns to map input data to output predictions through the iterative process of forward propagation and backpropagation, gradually improving its performance on a given task through training on known data. However, collecting this data may be very difficult. A process to generate valid data for training would be very useful.

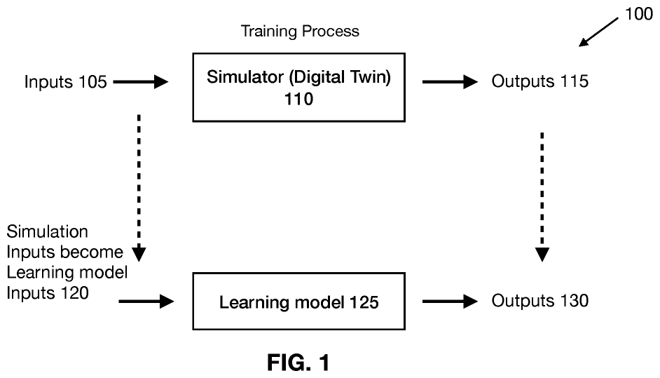

FIG. 1 at 100 discloses an overview of a training process to train a learning model while running a digital twin, such as a digital twin. We start by using an optimizer (not shown) to iteratively determine inputs 105 (node starting values) for a simulator 110. The digital twin is then run, producing outputs 115. At or near the same time, the digital twin inputs 105 are also used as inputs 120 into a learning model 125, which produces learning model outputs 130. The Simulator outputs 115 are considered ground truth in a cost function used in the learning model to determine how close the learning outputs 130 are to them. More specifically, the ground truth is compared with the learning model output in a cost function to produce a cost. That cost may then be used for backpropagation within the learning model to improve the output of the learning model. Backpropagation is an algorithm used to adjust the weights of connections between neurons in a neural network to minimize the error between a predicted output and the actual output. When the learning model is run with input and output from the optimizer digital twin, the learning model digital twin gets incrementally better at producing an outcome closer to that generated by the simulator/digital twin 110—it is trained.

Thousands of individual digital twins may be run during the process of optimization of a digital twin, each with an input and output set. Each of the simulator 110 input 105 and output 110 sets is then used for training the learning model. As the digital twin of a digital twin being discussed uses physics and a thorough understanding of the modeled structure to produce its results, the input and output from the optimizer digital twins can be used as real-world data sets, avoiding the problem of under- and over-fitting. After training, ideally, the learning model would now be able to produce outputs similar to that achieved by the digital twin even when given new problems. Even though the learning model can be considered trained, the digital twin, at a minimum, continues to be used to provide sanity checks on the results of the learning model, ensuring that the learning model continues to provide accurate answers, and if those answers are not acceptable, continuing the process of optimizing the digital twin inputs directly. This also greatly reduces the computational power required to run any given model, as training sets are generated automatically as a process of running the digital twin in its normal course of business, rather than using extra computing power; the trained learning model requires much less computational power and time to run than the digital twin, and so on.

### DETAILED DESCRIPTION

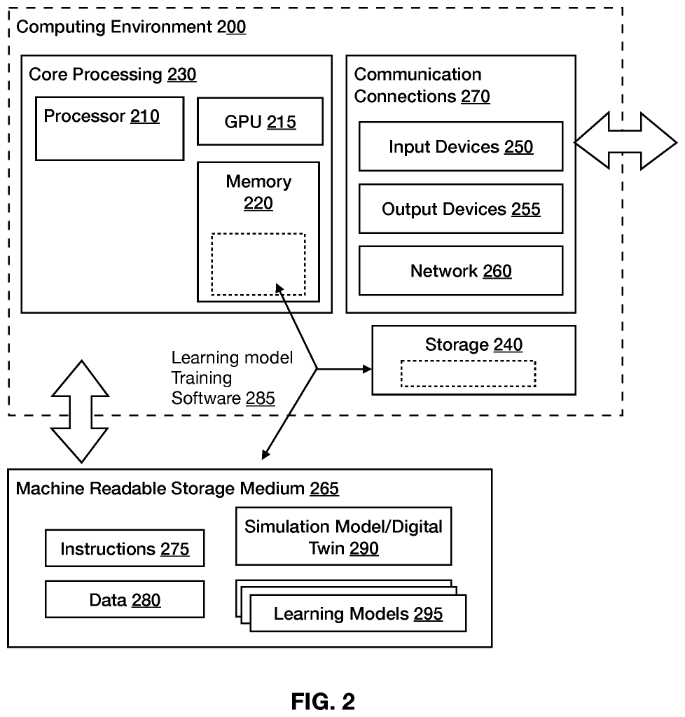

FIG. 2 illustrates a generalized example of a suitable computing environment 200 in which described embodiments may be implemented. The computing environment 200 is not intended to suggest any limitation as to scope of use or functionality of the disclosure, as the present disclosure may be implemented in diverse general-purpose or special-purpose computing environments.

With reference to FIG. 2, the core processing is indicated by the core processing 230 box. The computing environment 200 includes at least one central processing unit 210 and memory 220. The central processing unit 210 executes computer-executable instructions and may be a real or a virtual processor. In a multi-processing system, multiple processing units execute computer-executable instructions to increase processing power and as such a vector processor (not shown), GPU 215, and CPU 210 can be running simultaneously. The memory 220 may be volatile memory (e.g., registers, cache, RAM), non-volatile memory (e.g., ROM, EEPROM, flash memory, etc.), or some combination of the two. The memory 220 stores software implementing the described methods and systems using digital twins to train learning models.

A computing environment may have additional features. For example, the computing environment 200 includes storage 240, one or more input devices 250, one or more output devices 255, one or more network connections (e.g., wired, wireless, etc.) 260 as well as other communication connections 270. An interconnection mechanism (not shown) such as a bus, controller, or network interconnects the components of the computing environment 200. Typically, operating system software (not shown) provides an operating environment for other software executing in the computing environment 200, and coordinates activities of the components of the computing environment 200. The computing system may also be distributed; running portions of the software on different CPUs.

The storage 240 may be removable or non-removable, and includes magnetic disks, magnetic tapes or cassettes, CD-ROMs, CD-RWs, DVDs, flash drives, or any other medium which can be used to store information and which can be accessed within the computing environment 200. The storage 240 stores instructions for the software, such as software 285 to implement systems and methods of using digital twins to train learning models.

The input device(s) 250 may be a device that allows a user or another device to communicate with the computing environment 200, such as a touch input device such as a keyboard, video camera, a microphone, mouse, pen, or trackball, a digital camera, a scanning device such as a digital camera with a scanner, touchscreen, joystick controller, a wii remote, or another device that provides input to the computing environment 200. For audio, the input device(s) 250 may be a sound card or similar device that accepts audio input in analog or digital form, or a CD-ROM reader that provides audio samples to the computing environment. The output device(s) 255 may be a display, a hardcopy producing output device such as a printer or plotter, a text-to speech voice-reader, speaker, CD-writer, or another device that provides output from the computing environment 200.

The communication connection(s) 270 enable communication over a communication medium to another computing entity. The communication medium conveys information such as computer-executable instructions, compressed graphics information, or other data in a modulated data signal. Communication connections 270 may include input devices 250, output devices 255, and input/output devices that allows a client device to communicate with another device over network 260. A communication device may include one or more wireless transceivers for performing wireless communication and/or one or more communication ports for performing wired communication. These connections may include network connections, which may be a wired or wireless network such as the Internet, an intranet, a LAN, a WAN, a cellular network or another type of network. It will be understood that network 260 may be a combination of multiple different kinds of wired or wireless networks. The network 260 may be a distributed network, with multiple computers, which might be building controllers, acting in tandem. A communication connection 270 may be a portable communications device such as a wireless handheld device, a personal electronic device, etc.

Machine-readable media are any available non-transitory tangible media that can be accessed within a computing environment. By way of example, and not limitation, with the computing environment 200, machine-readable media 265 may include memory 220, storage 240, other similar but external devices accessible via a communications connection 270, and combinations of any of the above acting in concert. Machine readable storage medium 265 which may be used to store machine readable media includes instructions 275 and data 280. The instructions 275 may include instructions for implementing the various methods described herein such as, for example, instructions for running a digital twin using a digital twin, instructions for training a learning model, instructions for determining when a learning model needs retraining, instructions for performing gradient descent on a learning model or a digital twin to optimize a set of parameters, and so on. The machine-readable storage medium 265 may further store a digital twin 290 adapted to simulate a system (e.g., a real world system such as a building with controllable HVAC equipment that simulated temperature flow through multiple zones) and one or more learning models 295 that are trained to approximate various outputs of the digital twin 290. Data Sources may be computing devices, such as general hardware platform servers configured to receive and transmit information over the communications connections 270. The computing environment 200 may be an electrical controller that is directly connected to various resources, such as HVAC resources, and which has CPU 210, a GPU 215, Memory 220, input devices 250, communication connections 270, and/or other features shown in the computing environment 200. The computing environment 200 may be a series of distributed computers. These distributed computers may include a series of connected electrical controllers.

Although the operations of some of the disclosed methods are described in a particular, sequential order for convenient presentation, it should be understood that this manner of description encompasses rearrangement, unless a particular ordering is required by specific language set forth below. For example, operations described sequentially can be rearranged or performed concurrently. Moreover, for the sake of simplicity, the attached figures may not show the various ways in which the disclosed methods, apparatus, and systems can be used in conjunction with other methods, apparatus, and systems. Additionally, the description sometimes uses terms like “determine,” “build,” and “identify” to describe the disclosed technology. These terms are high-level abstractions of the actual operations that are performed. The actual operations that correspond to these terms will vary depending on the particular implementation and are readily discernible by one of ordinary skill in the art.

Further, data produced from any of the disclosed methods can be created, updated, or stored on tangible machine-readable media (e.g., tangible machine-readable media, such as one or more CDs, volatile memory components (such as DRAM or SRAM), or nonvolatile memory components (such as hard drives) using a variety of different data structures or formats. Such data can be created or updated at a local computer or over a network (e.g., by a server computer), or stored and accessed in a cloud computing environment.

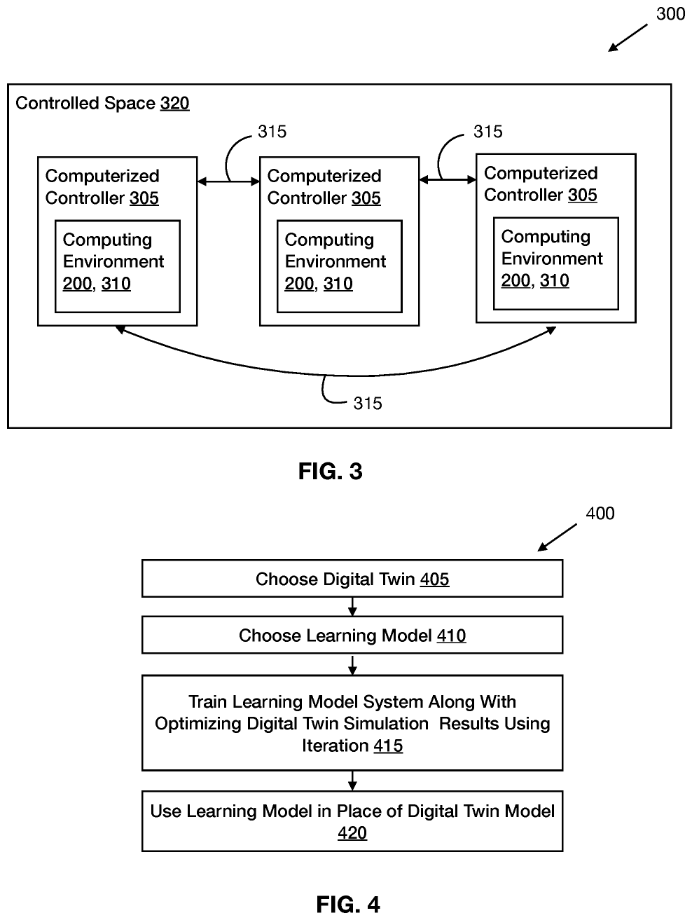

FIG. 3 depicts a distributed computing system 300 with which embodiments disclosed herein may be implemented. Two or more computerized controllers 305 may incorporate all or part of a computing environment 200, 310. These computerized controllers 305 may be connected 315 to each other using wired or wireless connections. The controllers may be within a controlled space 320. A controlled space 320 may be a space that has a resource, sensor, or other equipment that can modify or determine one or more states of the space, such as a sensor (to determine space state), a heater, an air conditioner (to modify temperature); a speaker (to modify noise), locks, lights, etc. A controlled space may be divided into zones, which might have separate constraint state curves. Controlled spaces might be, e.g., an automated building, a process control system, an HVAC system, an energy system, an irrigation system, a building-irrigation system, etc. These computerized controllers 305 may include a distributed system that can run without using connections (such as internet connections) outside of the computing system 300 itself. This allows the system to run with low latency, and with other benefits of edge computing systems. The computerized controllers may run using an internal network with no outside network connection. This allows for a much more secure system, much more invulnerable to outside attacks, such as viruses, ransomware, and just generally, computer security being breached in many other ways.

FIG. 4 at 400 is a flow diagram which describes at a high level training a learning model while a digital twin is being run. The learning model may be convex. The learning model may be a neural network. The neural network may be a recurrent neural network, an artificial neural network, a heterogenous neural network, In some embodiments, the computer-enabled method 400 may be implemented in one or more processing devices (e.g., a digital processor, an analog processor, a digital circuit designed to process information, an analog circuit designed to process information, a state machine, and/or other mechanisms for electronically processing information, a multiprocess system, etc.). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At operation 405, a digital twin is chosen. This may be a digital twin that resides in memory, that is imported from elsewhere, etc. Conceptually, the digital twin may be any sort of neural network that requires training, such as a digital twin. In implementations, the neural network may be non-convex; that is, it has one or more activation functions that are non-linear, though convex digital twins will work as well. Convexity and non-convexity are discussed with reference to FIG. 10 and the surrounding text. The created digital twin may be a heterogenous neural network. This heterogenous neural network may have activation functions in the nodes that perform separate calculations to determine weight values that are exiting the node, rather than a single activation function for an entire neural network. These separate calculations may be thermodynamic calculations that determines how state flows through the node. States may be characterized as weights entering and exiting nodes. An example of such a heterogenous neural network is described in patent application Ser. No. 17/009,713, “Neural Network Methods For Describing System Topologies,” filed Sep. 1, 2020 and incorporated herein by reference in its entirety. These digital twins may be digital twins that replicate the action of physical spaces.

In some heterogenous neural networks, such as digital twins, which might be used with embodiments described herein, the fundamentals of physics are utilized to model single components or pieces of equipment on a one-to-one basis with neural net nodes. When multiple components are linked to each other in a schematic diagram, a neural net is created that models the components (or portions of the components) as nodes. The values between the objects flow between the nodes as weights of connected edges. These neural nets may model not only the real complexities of systems but also their emergent behavior and the system semantics. Therefore, they bypass two major steps of the conventional Al modeling approaches: determining the shape of the neural net, and training the neural net from scratch. The nodes are arranged in order of an actual system (or set of equations) and because the nodes themselves include an equation or a series of equations that describe the function of their associated object, and certain relationships between them are determined by their location in the neural net. Therefore, a huge portion of training is no longer necessary, as the neural net itself includes location information, behavior information, and interaction information between the different objects represented by the nodes. Further, the values held by nodes in the neural net at given times represent real-world behavior of the objects so represented. The neural net is no longer a black box but itself contains important information. This neural net structure also provides much deeper information about the systems and objects being described. Since the neural network is physics- and location-based, unlike the conventional Al structures, it is not limited to a specific model, but can run multiple models for the system that the neural network represents without requiring separate creation or training.

In some embodiments, the heterogenous neural network shapes the location of the nodes to tell something about the physical nature of the system. It may also place actual equations into the activation function. The weights that move between nodes may be equation variables. Different nodes may have unrelated activation functions, depending on the nature of the model being represented. In an exemplary embodiment, each activation function in a neural network may be different. For example, a pump could be represented in a neural network as a series of network nodes, some that represent efficiency, energy consumption, pressure, etc. The nodes will be placed such that one set of weights (variables) feeds into the next node (e.g., with an equation as its activation function) that uses those weights (variables). Now, two previous required steps, shaping the neural net and training the model may already be performed, at least to a certain portion. Using embodiments discussed here the neural net model need not be trained on information that is already known. It still needs to be trained on other information.

In some embodiments, the individual nodes represent physical representations of chunks of building material within a structure, equipment, etc. These individual nodes may hold parameter values that help define the physical representation. As such, when the neural net is run, the parameters helping define the physical representation can be tweaked to more accurately represent the given physical representation. This has the effect of pre-training the model with a qualitative set of guarantees, as the physics equations that describe objects being modeled are true, which saves having to find training sets and using huge amounts of computational time to run the training sets through the models to train them. A model does not need to be trained with information about the world that is already known. With objects connected in the neural net like they are connected in the real world, emergent behavior arises in the model that maps to the real world. This model behavior that is uncovered is otherwise too computationally complex to determine. Further, the nodes represent actual objects, not just black boxes. The behavior of the nodes themselves can be examined to determine behavior of the object, and can also be used to refine the understanding of the object behavior.

A typical neural network, as opposed to a heterogenous neural network includes inputs, outputs, and hidden layers connected by edges which have weights associated with them. The neural net sums the weights of all the incoming edges, applies a bias, and then uses an activation function to introduce non-linear effects, which basically squashes or expands the weigh/bias value into a useful range; often deciding whether the node will, in essence, fire, or not. This new value then becomes a weight used for connections to the next hidden layer of the network. The activation function on such a typical neural network does not do separate calculations, depending on the node, does not have physics equations associated with them, etc. Such a typical neural network may have a single activation function for the entire neural network.

At operation 410, a learning model is chosen. The learning model may be a neural network (such as the typical neural network described above), or a similar sort of network that accepts input, and after training, produces trained output. This learning model may have the same number of inputs and the same number of outputs as the digital twin. The learning model may be any sort of digital twin that determines outputs from inputs after seeing enough training examples. This learning model may be, without limitation, a recurrent neural network, a convolution neural network, a feed forward neural network, a multilayer perceptron, a long/short term memory (LSTM), a gated recurrent unit (GRU), an auto encoder (AE), a variational AE (VAE), a denoising AE (DAE), a deep convolutional network, (DCN), and so on. The learning model may be convex, that is, may have a higher chance of finding a global minimum than local minima, as opposed to a non-convex neural network. Thus, the digital twin and the learning model (once trained, and weights frozen) may have different space shapes for solving a given digital twin input problem. At operation 415, the digital twin input is optimized by iterative runs. During the optimization, each of the inputs and outputs of the digital twin run during optimization are used to train the learning model. For a given run of the digital twin, the digital twin input is used as input for the learning model, and the digital twin output is used as ground truth in a cost function used to iteratively train the learning model. At operation 420, once the learning model has been optimized, the learning model used in place of the digital twin. The results of the optimized learning model may then be used to modify a real-world structure, object, etc., that has been modeled.

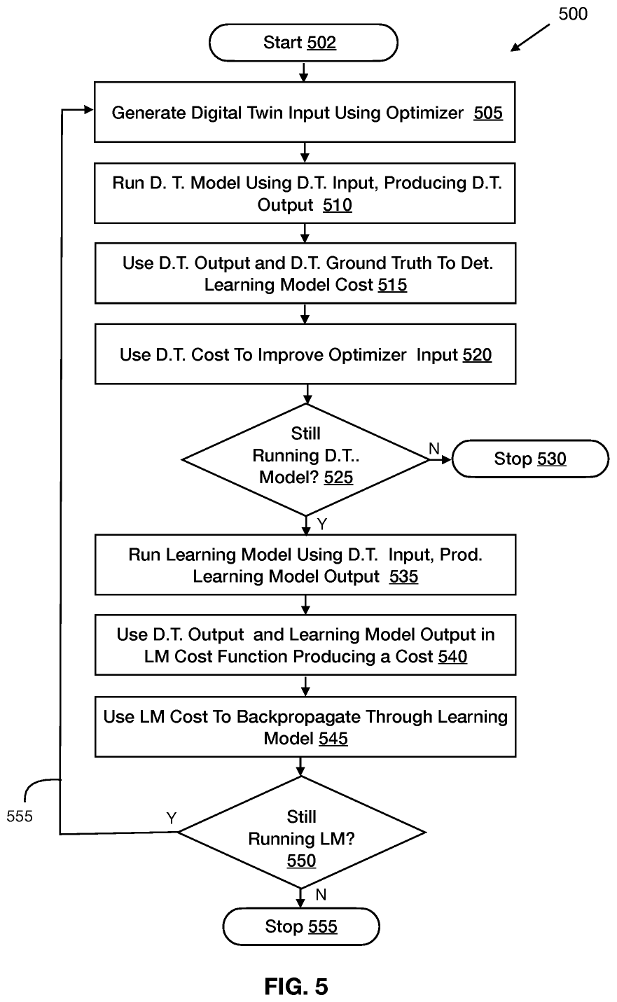

FIG. 5 at 500 is illustrates an example of a method for training a learning model while a digital twin is being run. This digital twin may be a digital twin. In various embodiments, the method 500 may be performed by a processor 210 within a device, a processor 210 within a controller 305, multiple processors 210 within a distributed system, e.g., 300, etc. Various alternative arrangements and methods of training a learning model will be apparent.

The method starts at operation 502. At operation 505, input for the digital twin is created. In some embodiments, an optimizer may choose initial state value node inputs for the digital twin, and node inputs afterwards. In some embodiments, several optimizers may be used in different portions of the method 500. The optimizer may be an optimization algorithm. These optimization algorithms or optimization methods may include Gradient Descent, methods based on Newton's method, and inversions of the Hessian using conjugate gradient techniques, Evolutionary computation such as Swarm Intelligence, Bee Colony optimization; SOMA, Particle Swarm, Non-linear optimization techniques, and other methods known by those of skill in the art.

At operation 510, the digital twin runs using the digital twin input from the optimizer. The digital twin is running to match to a desired digital twin output, within some value, range of values, or percent. It may run until a predetermined value is met, etc. This desired digital twin output is generally known as the ground truth. At operation 515, the actual digital twin output and digital twin ground truth are used in a digital twin cost function to determine a digital twin cost, which is how far apart the current digital twin output is from the desired digital twin output. At operation 520, the digital twin cost is used to improve the input values coming from the optimizer. At decision point 525, it is determined if the digital twin should run for another iteration. This may involve determining what the cost function is, if the cost function is below a threshold value, if it is between two values, etc. The digital twin may also stop running if it has run for a certain number of iterations, if it has run for a certain amount of time, etc. If it is determined that the digital twin should stop running, then at 530, the method stops. If, at at decision point 525, it is determined that the digital twin is to continue running, then at operation 535, the learning model is run using the digital twin input as the learning model input. This produces learning model output. In some iterations, the learning model has the same number of inputs and outputs as the digital twin. At operation 540 the digital twin output and the learning model output are used in a cost function to produce a learning model cost. This cost tells how far apart the learning model answer and the digital twin answer are. At operation 545, the learning model cost is used to backpropagate through the learning model, modifying its internal weights to more closely approximate the digital twin answer.

At decision point 550, it is determined if the learning model should still be running. For example, the learning model cost function may be at a value that indicates that the learning model has learned enough, the learning model may have previously run for a predefined number of iterations, may have previously run for a certain time, may have previously had a certain learning model cost value, etc. Any or none of these may be used to determine if the learning model should continue. In some implementations, a goal function is used to determine if the cost is such that the operation can stop. Some implementations also include a stop state; a secondary state, such as another quit option, such as quit if an optimizer or the simulator has run for a certain amount of time, or has run for a number of cycles. If it is determined that the learning model still longer needs to run, then the method may continue at operation 505, where another iteration of the digital twin runs.

If, at at decision point 550, it is determined that the learning model is to run no longer, then at operation 555, the method stops. This may indicate that the learning model has been sufficiently trained.

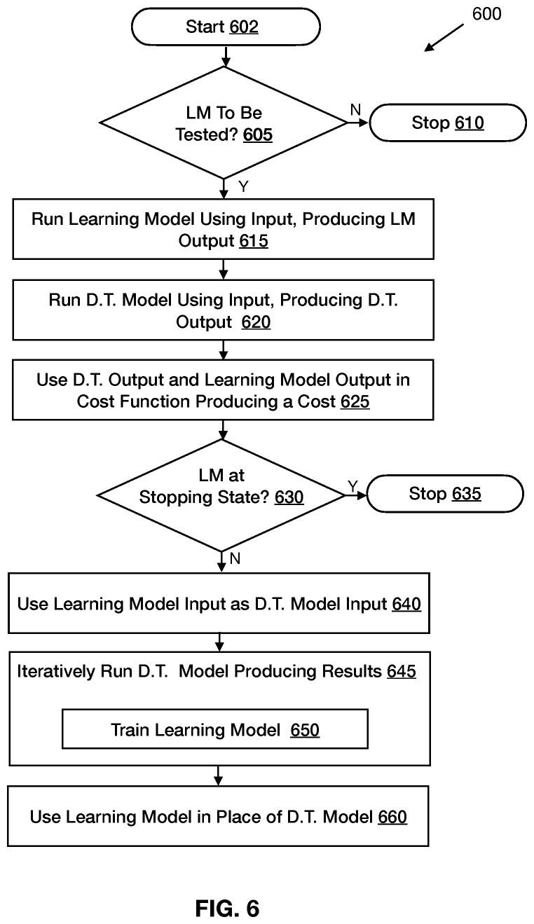

Once a learning model has been trained, it still may need to be checked at times to be sure that it is performing correctly. FIG. 6 at 600 discloses a method to use a digital twin to check the accuracy of a learning model. In various embodiments, the method 600 may be performed by a processor 210 within a device, a processor 210 within a controller 305, multiple processors 210 within a distributed system, e.g., 300, etc. Various alternative arrangements and methods of training a learning model will be apparent.

At times, the learning model may be determined to be of insufficient accuracy. This may occur if the learning model does not produce a sufficient answer within a given time frame, a number of iterations, etc. So, the learning model may be tested to determine if it is performing adequately. At operation 602 the method begins. At operation 605, it is determined if a learning model is to be tested. A learning model may be tested every time, randomly, for certain classes of problems, etc. If the learning model is not to be tested, then at operation 610, the method stops.

At operation 615, the learning model is run with learning model input, producing learning model output. At operation 620, the digital twin is run using the same learning model input, producing digital twin output. In some embodiments, an iterative digital twin may be run to an optimal value, which is then checked against the single learning model run. In some embodiments, one, a few, a set amount, etc., of the digital twin may be run using optimization techniques. At operation 625, the learning model output and the digital twin output are used in a cost function, producing a cost. This shows how far apart the answers are. At decision point 630, it is checked to see if the learning model output has produced accurate enough results. This may be an analysis of the cost, such as, if the cost meets some standards that indicate that the digital twin output and the learning model output is close enough. This may involve other analysis of the difference between the two outputs. If it is determined that the digital twin output and learning model output are sufficiently close, then at 635, the method stops. At this point, the output may be used to modify an article, building, etc., being simulated. If a stopping state has not been reached, that is, the learning model may need additional tuning, then the method continues at operation 640.

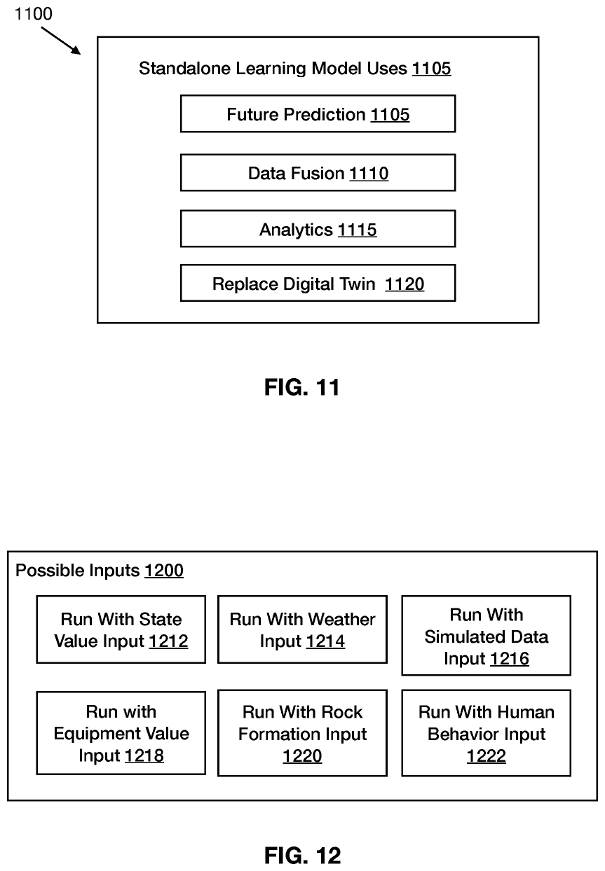

At operation 640, the learning model input, as it stands may be used as digital twin input. Using the learning model input as input into the digital twin may provide a good starting point for a digital twin optimizer input function, even if the learning model has not provided a direct answer. At operation 645, the digital twin is run iteratively. While it is being run, at operation 650, the learning model is simultaneously trained, while simultaneously training the learning model 650 using the digital twin input, and checking the learning model output against the digital twin output as described more fully with reference to FIG. 5. The Iterative running-training steps 645-650 may continue until the digital twin is optimized or until another stopping state is reached. A more in-depth discussion of these steps can be found with reference to FIGS. 4 and 5 and the surrounding text. Once the digital twin has been trained, at operation 660, the results may used in an article, building, space, experiment, etc., being controlled. At 665, the method ends. FIG. 11, described below, gives examples of some exemplary uses for the learning digital twin.

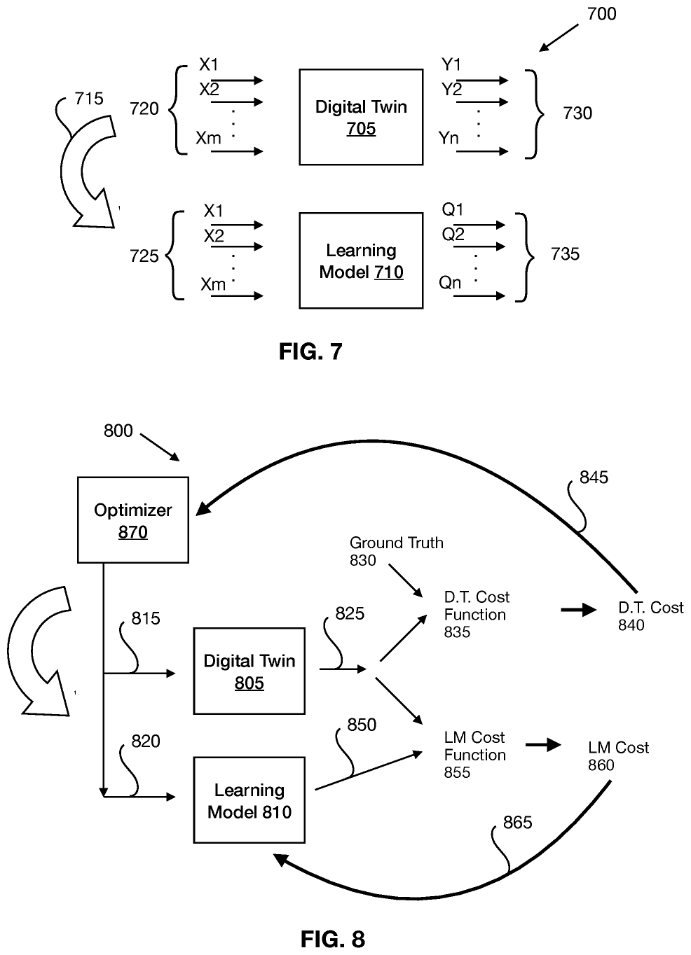

FIG. 7 at 700 discloses using simulator model output as learning model input. In embodiments, the digital twin 705 and learning model 710 have an equal number of inputs, and an equal number of outputs. In some embodiments, the digital twin and the learning model have the same inputs. For example, digital twin 705 has inputs 720 that run from X1 to Xm. These same inputs, X1 to Xm 725 are used 715 in the learning model 710. The digital twin 705 produces outputs Y1-YN 730. The Learning model 710 produces the same number of outputs, Q1 to Qm, 735 although, as both models are run, the learning model outputs 735 and digital twin outputs 730 are expected to start out quite a bit different and then converge. In some embodiments, digital twin output Y1 is matched with learning model output Q1, Y2 to Q2, all the way to Yn to Qn to determine distance between the digital twin 705 and the learning model 710. In some embodiments there may be a different number of inputs than outputs, and a different way of matching inputs to outputs.

FIG. 8 at 800 discloses embodiments of the digital twin 805 and the learning model 810 interacting. The digital twin 805 and learning model 810 both take inputs 815, 820 from an optimizer 870. The optimizer 870 may determine the next set of inputs based on the calculated digital twin cost 840 from the application of the digital twin cost function, 835. In some embodiments, the optimizer may produce random input numbers to feed to the digital twin to train a learning model. The digital twin 805 then runs producing output 825. The digital twin output 825 is compared to a ground truth 830 using a digital twin cost function 835 to produce a digital twin cost 840. The ground truth 830 may be an answer that the right inputs are expected to produce. For example, the inputs may be controls on equipment in a zone, and the output is the expected temperature. The cost function used here tells us how close the digital twin is to being optimized (e.g., how close the simulated temperature is to the desired temperature). This cost is then used 845 to by the optimizer 870 to choose a different (desirably, better) set of inputs until a stopping state is reached, such as a desired state, which may be a given temperature, a value between two temperatures, a threshold temperature has been reached, and so on. At the same time that the digital twin is running, the learning model 810 inputs the same input 820 from the optimizer 870 and produces its own output 850. This output 850 is used in a learning model cost function 855 which measures how close the learning model output is to the digital twin output 825 to produce a learning model cost 860. This cost 860 tells us how close the learning model and digital twin outputs are for a given set of inputs. The learning model cost 860 is then used 865 to backpropagate through the learning model. Backpropagation, in some embodiments, briefly, propagates the cost through the learning model, modifying the weights in it such that the cost is lowered.

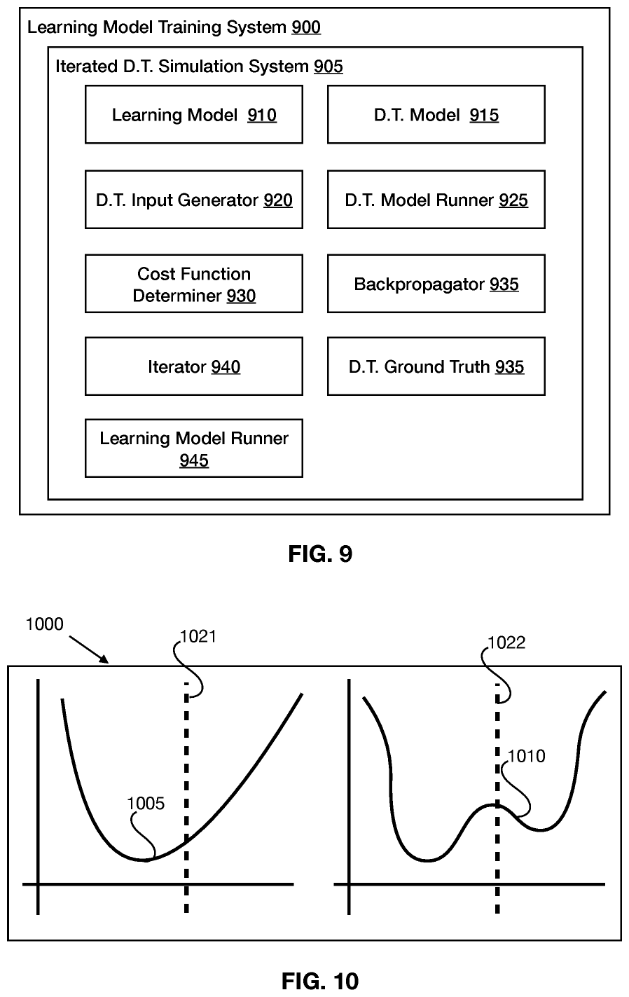

FIG. 9 illustrates an example of a leaning model training system 900 used to train a learning model using an imitation simulator. The learning model training system may include a processor, such as the processor, e.g., 230, 210 and a memory 220 in operable communication with the processor. The memory 220 may itself include learning model training software 285. The learning model training software 285 may include an iterated digital twin system 905. This iterated digital twin system 905 may include a learning model 910. This learning model may interface with a digital twin 915, which may be a digital twin or a different sort of digital twin. There may also be a digital twin input generator 920. In some embodiments, the digital twin input generator 920 may be an optimizer 870. There may also be a digital twin runner 925 that runs the digital twin 915 using the digital twin input, producing digital twin output. A learning model runner 945 may also be included that runs the learning model using the digital twin input, producing learning model output. The digital twin output and the learning model output may then be used in a cost function determiner 930 that uses the digital twin output as learning model ground truth which it compares to the learning model output producing a cost. A backpropagator 935 may also be used which uses the cost determined from the cost function to backpropagate through the learning model as a part of improving values of parameters of the learning model.

In embodiments, an iterator 940 may iteratively run the digital twin input generator, 920 the digital twin runner 925, the learning model runner 945, and the cost function determiner 930. The iterator 940 may take output of the digital twin input generator and feed it into both the digital twin runner 925 and the learning model runner, 945 such that both the digital twin and the learning model run with the same input. The cost function determiner 930 may compare the learning model output and the digital twin output to determine the learning model divergence from the digital twin, the cost. The digital twin 915 and the learning model 910 may both have the same number of input and output nodes. A portion of the output nodes for the digital twin 915 or the learning model 910 may be grouped to form a set of nodes used to determine how close the model (learning or digital twin) is to a ground truth. In some embodiments, there may be a separate set of nodes used by the cost function determiner in the cost function to determine how close the given model is to a ground truth. In some embodiments, there may be specified nodes as input that are used to determine certain starting values.

As will be understood by a person of ordinary skill in the art of optimization, when a cost function is used for the training step, the cost function may be set up to correlate training weights internal to the model being trained to the error in the output—typically a difference between the output produced and the expected output of a training example. Such a cost function may be used, as described above, to train one or more learning models.

According to various embodiments, once a learning model is trained, and its weights frozen, a different cost function can be used to tune the inputs to produce a desired output. For example, where the learning model accepts possible control actions as input and outputs a predicted state curve for one or more zones, an application may tune the inputs until the desire state curves are predicted. The final inputs may then be useful in actually controlling the system to produce the desired states. In such an arrangement, the cost function may instead relate the inputs (instead of internal training weights) to the error in the output—this time the difference between the output produced and the desired output (e.g., the desired behavior of the system). From here, by tuning the inputs to minimize the cost function, a suitable input set may be discovered. While various tuning methods may be employed, in some embodiments autodifferentiation may be used to ensure that partial derivatives of the cost function are available at runtime. With the availability of partial derivatives, the method can use gradient descent to find a minimum on the cost function and, therefore, the ideal inputs approximated by the learning model to produce the desired result. In some embodiments, the learning model may be used in place of the digital twin to identify, e.g., what controls or other actions to take to product a desired result.

Similarly, a cost function for optimizing inputs can be created against the digital twin instead of the learning model. Such a cost function may relate control actions (or other parameters) to a cost such as a difference of one or more state values or curves extracted from one or more neurons of the digital twin with the desired values or curves. Again, through use of autodifferentiation, partial derivates may be made available on this cost function and gradient descent may be performed to optimize the inputs to a minimum on the cost function. As will be explained in greater detail below, however, the complexity of the digital twin may lead to a more complex cost function and a higher likelihood of local minima. Local minima in the cost function may pose a challenge to finding truly optimal inputs; however, the use of one or more learning models can help overcome this challenge, while ultimately optimizing inputs against the digital twin itself rather than the learning model as a proxy therefor.

FIG. 10 at 1000 illustrates an example of two different curves 1005, 1010 representing two different cost functions. For example, the first curve 1005 may represent a cost function of a learning model, e.g., 125, while the second curve 1010 may represent a cost function of a digital twin, e.g., 110, such as a digital twin. As shown, the first curve 1005 is less convex (informally) than the second curve 1010: the first curve 1005 has only a single global minimum while the second curve 1010 has a local minimum (on the right side) in addition to a global minimum (on the left side). Such a difference in convexity may occur naturally, due to the lower complexity of the learning model, or may be enforced by design through, for example, constraining the number of inputs into the learning model as compared to the digital twin, applying a smoothing techniques, such as regularization, during the learning model's training, and so on.

It will be appreciated that the curves 1005, 1010 are, in some respects a simplification. For example, both curves 1005, 1010 are two dimensional and, as such, take one variable as an input. It will be appreciated that in a real application, both curves 1005, 1010 are likely to have multiple input variables and, as such, the curves 1005, 1010 would actually be 3-, 4-, or any n-dimensional surfaces.

As can be seen, the cost function associated with the first curve 1005 is more likely to be successful in locating the global maximum through gradient descent (e.g., identifying an optimal set of inputs to minimized output error compared to a desired result) than the cost function associated with the second curve 1010. To the left of a particular input set 1022 on the right curve 1010, gradient descent may properly locate the global minimum, but to the right of that input set 1022, gradient descent may instead locate the local minimum to the right. This would not likely happen on the cost function represented by the left curve 1005; gradient descent beginning at the same input set 1021 (or possibly at any valid input set) would successfully find the single global minimum for that cost function. After finding the learning model-optimized input set, that input set can be used to begin another gradient descent process, this time on the cost function associated with the right curve 1010. With inputs moved to the left of the original input set 1022 by the first gradient descent, this second gradient descent is more likely to successfully find the global minimum of the digital twin cost function, and thereby optimize the control inputs for the desired result (or optimize whatever inputs apply to the context in with the embodiment is deployed).

FIG. 11 at 1100 discloses illustrative use cases for a learning (imitation) simulator. One use case is future prediction 1105. Once a learning simulator has been created, it may represent a learning neural network version of a heterogenous digital twin of a building, structure, equipment set, etc. When doing so, it can be run with proposed inputs to produce predictions for future behavior of the system being simulated. Another use case is data fusion 1110. Data fusion relates to determining unknown values in a model neural network, determining where in the model those neuron values were derived from, and determining the quality of data within the model representation, when compared to a physical location. For example, when the learning model is set up to represent data points, only some of which are known, some input and output neuron values may represent known data values. Other neural input and output data values may represent unknown data values. The known output data values can be used with the outputs representing unknown data values in a data fusion calculation. The present application hereby incorporates by reference the entirety of U.S. patent application Ser. No. 17/336,640, filed Jun. 2, 2021, which discusses data fusion. Another possible use is analytics 1115. As learning simulators may be set up to model physics-based heterogenous neural networks, they may be created to mimic these models, such as those for specific equipment, and/or connected equipment. They may also be set up to mimic models of specific buildings, areas of buildings, or areas. These learning simulators may then be run to determine desired analytics; that is how specific parts of the system behave (outputs) under a variety of initial values (inputs). These areas may be industrial, commercial, residential, governmental, scientific, etc.

A standalone learning model may also be used 1120 to replace a digital twin in that the learning model may have a different cost function space than the digital twin it was trained on. In such cases, the learning model may be run and used to provide a good starting set of values for the digital twin, may run faster than the digital twin, and so forth.

FIG. 12 describes some possible input types 1200 for use with the methods and systems taught herein. Input types may be state values within a building, such as temperature, humidity, etc. Input types may be state values that are derived from weather. Input types may be simulated input data. This simulated input data may be generated by digital twins or learning models. Further, equipment values 1218 may be used as input, as well as rock formation values 1220, human behavior values 1222, etc.

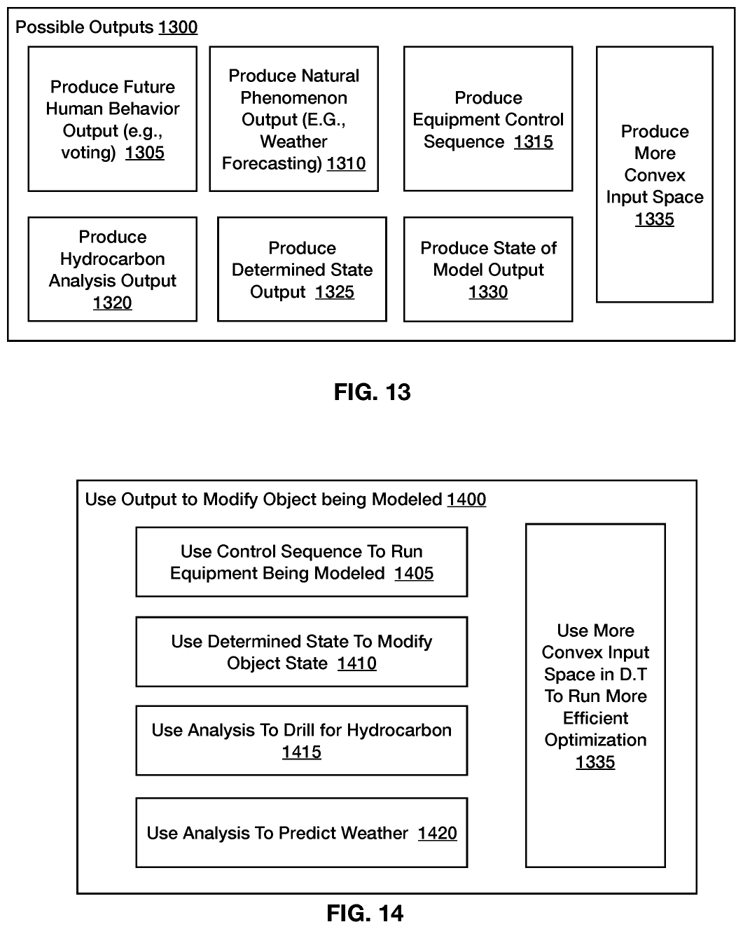

FIG. 13 at 1300 describes some possible output types that may be generated using methods and systems taught herein. The output may be future human behavior 1305 such as voting, natural phenomenon output such 1310 such as weather forecasting, equipment control sequences 1315, hydrolocation analysis output, determined state output, such as the amount of state necessary to achieve another state, such as how much heat needs to be pumped into a zone to maintain a temperature of, say, 70 degrees; state of model output, that is what specific values does a model have at a certain time, under a certain condition, etc.

FIG. 14 at 1400 describes some possible uses of output of digital twins and learning models as described herein. One should remember that the learning model is very versatile, as many simulators with inputs and outputs can be modeled, allowing a vast range of use cases. A few non-limiting use cases will be disclosed here. A control sequence generated may be used to run equipment that was modeled; determined state may be used to determine how to best use equipment to reach that state, and then to modify the state of the object or space that was modeled. Further, hydrocarbon analysis output may be used to drill for hydrocarbons; natural phenomenon output may be used to predict the weather, and so on.

One use case is future prediction 1105. Here, we may run the learning model with known input for a given amount of time and receive simulated state at the future simulated time. As an illustrative example, a digital twin simulator may be created such that it accepts as inputs values that affect a building, such as weather 1214. These may be state-time curves. When weather inputs are given, the simulator may then determine how to best run equipment in the building. These outputs may be equipment control sequences 1315. The equipment control sequences may then be used 1405 to run the equipment being modeled. In another exemplary use case, the digital twin may be set up to determine human behavior, such as voting behavior. Human behaviors associated with, e.g., voting or other behavior may be input, 1222, and future human behavior (e.g., voting behavior), 1305 may be output. As another exemplary use case, natural phenomena such as satellite data, stream gauges, aircraft observations, etc., of the atmosphere of earth or a different location may be input 1214, with the output being an analysis 1310 that can then be used to produce weather forecasts 1420. An object may be simulated. The object may be something being simulated, such as equipment, a portion of a building, a group of people, or a portion of the natural world. This may be the atmosphere, for modeling natural phenomena; e.g., weather; or may be a portion of the ground, such as when modeling drilling possibilities, a set of streets, such as for modeling vehicle behavior, etc.

Another use case is data fusion 1110. Data fusion is, in general, combining disparate data to seemingly get more information out than was put in. More specifically, it entails combining data from different sources and analyzing it such that the different data sets and data views allow one to more fully understand what is being observed than any single data set allows.

Building models often have sparse data sets; there are only so many sensors in a building; large spaces generally only measure temperature (or other state values) near walls. This leads to buildings whose heating and cooling is very difficult to control, as large portions of the building do not have simple ways of measuring state values, and if they are not measured, it is very difficult to alter them. Who has not been in an office where the thermostat is next door? No matter the temperature of your office, since it is not measured with a sensor, you are at the mercy of the person the next office over, and their desired temperature setting. Using data fusion with the values generated from a learning digital twin can generate many missing data values.

Within an exemplary context, data fusion relates to having a digital twin that has outputs that represent known sensor values and outputs that represent unknown sensor values. An exemplary digital twin through its physics-based digital twin of both the building materials and the equipment may be able to simulate, for example, the temperature within all the zones within a building. The learning model, when built, may have weather time state values as input and time state values of temperature locations that include both known sensor locations and locations without sensors as output. When run, the learning model outputs then can be used to determine how close the outputs that represent the known sensor values are to the known sensor values. The error rate between the learning model derived sensors and the real sensors to determine how accurate the outputs without matching sensor values are, using a data fusion calculation. The present application hereby incorporates by reference the entirety of U.S. patent application Ser. No. 17/336,640, filed Jun. 2, 2021, which discusses data fusion.

Another possible use is analytics 1115. As learning models may be set up to model physics-based heterogenous neural networks, digital twins may be created to mimic these models, such as those for specific equipment, and/or connected equipment. The learning models may have inputs that represent simulated data 1216, such as state value inputs. Similarly, the inputs may represent historical data. These models may have outputs that represent values for internal values of the model 1330, such as specific equipment values, values of variables associated with the equipment, values of variables associated with parts of a building being modeled, values representing atmospheric state, values representing possible presence of desired substance, such as hydrocarbons, etc. The trained learning model then will have outputs that correspond to the desired analytics. For example, the inputs may be time-state curves of forces acting on the system being modeled 1212, with outputs of time-state curves of the state of for example, state such as zones temperature 1325, internal equipment values 1330, etc. These learning models may then be iteratively run to determine desired analytics; that is how specific parts of the system behave (outputs) under a variety of initial values (inputs). In some embodiments, the object being simulated may comprise connected equipment. This may allow the behavior of specific equipment under certain conditions to be determined. In some instances the learning model output may produce a more convex input space than that of the original digital twin. This may allow the digital twin being modeled by the learning model to run a more efficient optimization 1335 using the determined outputs from the learning model. In other exemplary embodiments, the model may input equipment feature values 1218, such as amount of energy required, specific equipment types, etc. Iteratively running the learning model may then be able to determine how different equipment behaves in the system, allowing one to choose that which best fits the operational targets, thus modifying the equipment (object) state 1410, as equipment may have its parameters modified, may be swapped out for a different device, etc. In another exemplary use case, a digital twin can be set up to accept a geological feature, such as a rock formation as input 1220 and then produce as output locations 1320 within the geological feature such as portions of a rock formation where hydrocarbons have have a higher incidence of being found. The location analysis 1415 may then be used to drill for the locations where the learning model has indicated hydrocarbons have a high chance of being found 1415.

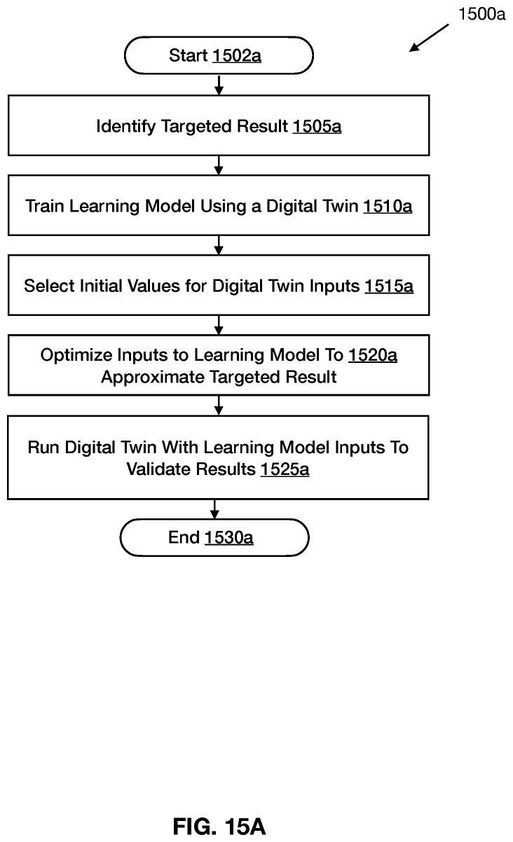

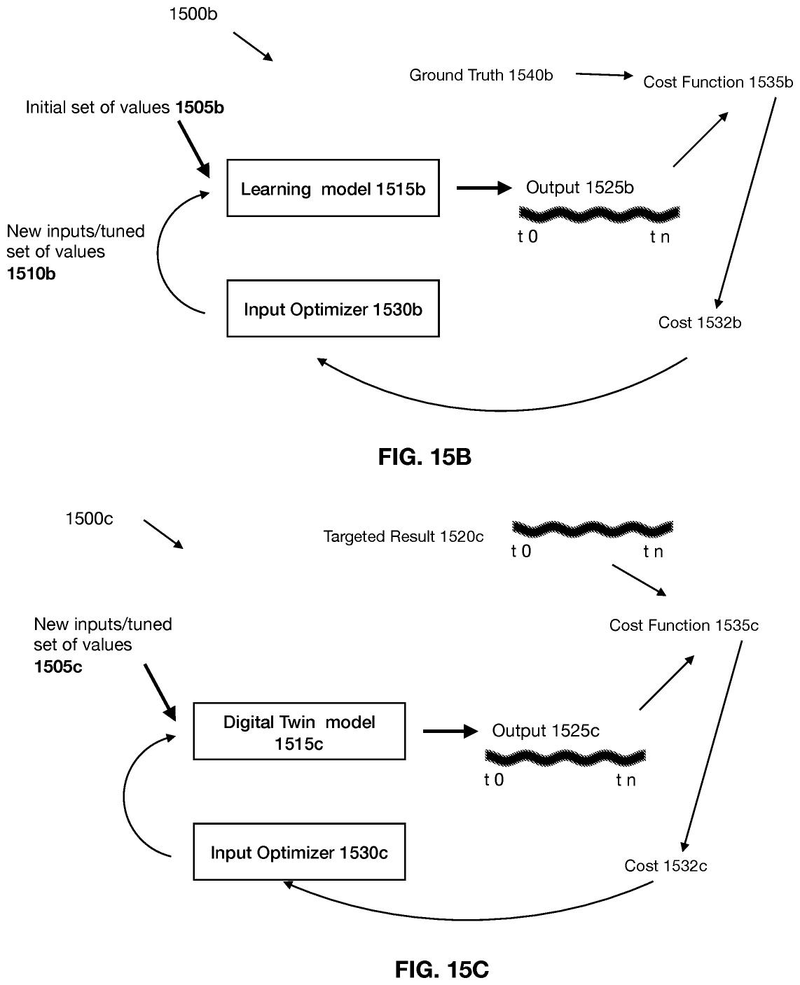

FIG. 15A at 1500a discloses a method to use a learning model to provide starting values to a digital twin value. These starting values may be associated with a simpler cost function that allows the digital twin to solve its problem with greater ease, quicker, etc. The starting values may be associated with a simpler set of solutions to the cost function that allow the learning digital twin to approach an optimal solution quicker, etc. In various embodiments, the first cost function and the second cost function may be the same cost function. In various embodiments, the method 1500a may be performed by a processor 210 within a device, a processor 210 within a controller 305, multiple processors 210 within a distributed system, e.g., 300, etc. Various alternative arrangements and methods of using a learning model to provide starting values for a digital twin value will be apparent.

The method starts at operation 1502a. At operation 1505a, a targeted result is identified. This targeted result may be the results to be achieved when running a digital twin. This targeted result may be a component of the digital twin, as described above. The targeted result may be results desired, more globally, within a location represented by a digital twin, of which the digital twin and the learning model are portions of, etc.

At operation 1510a, a learning model is trained using a digital twin. This is described with reference to FIGS. 7 and 8. This learning model may be trained to access an initial set of parameters, e.g., 720, 725 as as input, and produce output e.g, 735. This output may approximate a component of the digital twin. This component should be understand broadly. It may be something such as an amount of energy needed to bring a zone up to a given temperature, the temperature in a zone, comfort values for a zone, energy used by the zone, a specific state value (or values) within a zone, such as humidity, temperature, radiant temperature, sound, occupancy, indoor air quality, CO2 concentration, light intensity, etc. The component may also be a specific value (values over time) for a piece of equipment/resource/device within a digital twin, etc. The digital twin itself may be trained on a ground truth 830 that may be a targeted result. At operation 1515a, an initial set of values is selected for inputs for the digital twin. These initial set of values may be chosen randomly, may be chosen using a heuristic, may be chosen in a different manner, etc.

At operation 1520a, the inputs to the learning model is optimized, running on its own, to optimize the targeted result. FIG. 15B at 1500b is an example of a learning model running separately. In some embodiments, the learning model is trained using the digital twin and then runs on its own, modifying its input to better fit a targeted result. This targeted result may be a ground truth 830 that the digital twin was optimized to match with the training of the learning model. The initial set of values 1505b previously chosen for the digital twin is used as the first input for the learning model. In some embodiments, the initial set of values is sent randomly (within possible values). In some embodiments, the initial set of values is chosen in a different matter. In the illustrative embodiment, the initial set of values 1505b is a control for a resource over time that is parameterized and used as input to the learning model 1515b. The learning model runs, and produces output 1525b (in this case, a time series). The output is then checked against a first cost function 1535b which may use the targeted result as ground truth 1540b. An input optimizer 1530b, as discussed earlier, then uses the first cost function values 1532b to transform the inputs that were used into a new set of inputs whose learning model output should more closely approximate the targeted result. This continues for a number of iterations, it may be one iteration, it may be some given number of iterations, the iterations may continue while another program (such as the digital twin) is running, it may continue for a set amount of cycles, it may continue until the output of the learning model is within a threshold value of the targeted result, etc. After the learning model has stopped running, then the set of values that was last used to run the learning model is considered the first tuned set of values 1510b.

At operation 1525a, the learning model inputs are used as inputs in the digital twin model to validate the results. If the differences between the learning model outputs and the digital twin outputs are too far apart, this is an indication that the learning model needs more training. At operation 1530a the method ends.

FIG. 15C at 1500c illustrates an example of a digital twin running using input values from a learning model. Initially, the digital twin uses the first set of tuned values 1510b, 1505b that are the last input used in the “optimize learning model to targeted results 1520a operation. The first tuned set of values 1505c are used as the first set of values for the parameters that are used as input for the digital twin 1515c. The digital twin then outputs approx. targeted results 1525c (in this example, a state-time curve) which is compared with the digital twin output 1525c (in this example, another a state-time curve), using a second cost function 1535c. In some embodiments, the first and second cost function are the same or similar cost functions. The values of the second cost function 1535c (a cost 1532c) are then used by an input optimizer to determine a new set of input values that will more closely approximate the targeted result 1520c. When the results are optimized, then the last set of input values used becomes the second tuned set of values. At operation 1530c, the method ends.

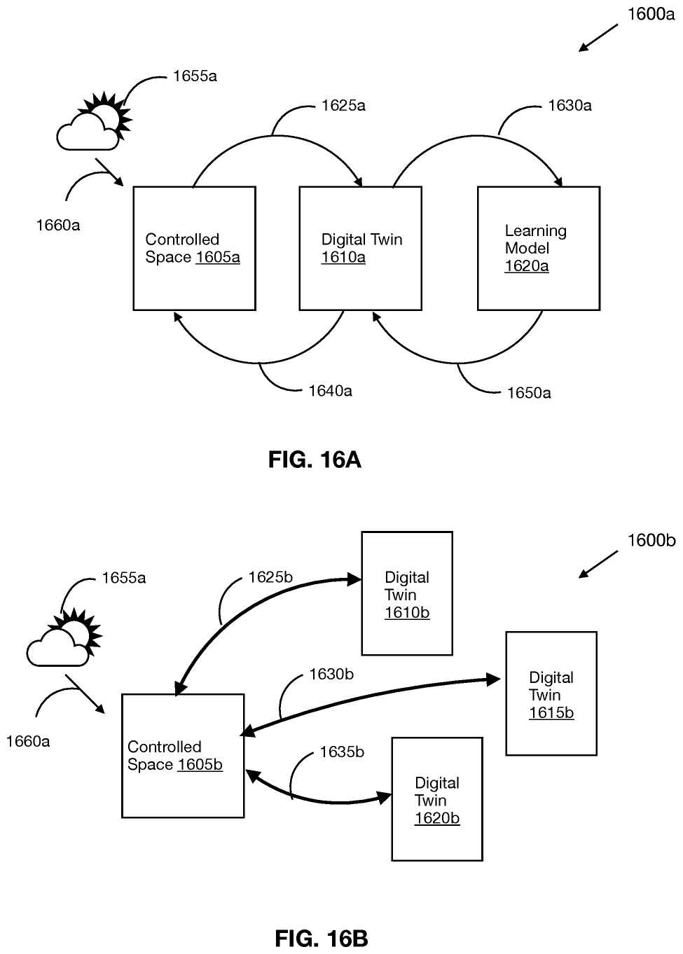

FIG. 16A illustrates an example of a system 1600a that shows interactions between a controlled space 1605a, a digital twin 1610a and a learning model 1620a. The system 1600a shown illustrates various functional components and some interactions therebetween. The information traveling between the different chunks 1625a-1640a may be encoded, may be sent plaintext, etc. A controlled space 1605a, e.g., a controlled space 320, sends information 1625a to a digital twin 1610a. This information may be in the form of sensor information about the controlled space 1605a. This information 1625a may be information about the controlled space 1605a that allows the digital twin to be created, to be refined, etc. For example, the controller may send information about a pump that operates in this controlled space 1605a. This may include a physics-based digital twin that explains behavior of a piece of HVAC equipment, e.g., a pump. Location information of a device may also be included in the information 1625a. The information 1625a may be information 1660a about current weather 1655a that affects the controlled space 1605a, historical information about the weather at the location of the controlled space 1605a, etc. Other sorts of information (e.g., occupancy number) may also passed from the controlled space to the digital twin. This information 1625a may be information about the controlled space 1605a that allows the digital twin 1610a to be created, to be refined, etc. For example, the controller may send information about a pump that operates in this controlled space. 1605a This may include a physics-based digital twin 1610a that explains behavior of a pump. The digital twin 1610a may then take this information and use it to hone its information about the controlled space 1605a, making the digital twin 1610a more perfectly mirror the controlled space 1605a. In general, the digital twin 1610a takes information 1625a from the controlled space 1605a and transforms it.

Running the digital twin 1610a may be an iterative process, as, e.g., described with reference to FIGS. 4 and 5. Each of these iterations produces input and output, with the runs getting sequentially closer to a best answer. This input and output from the sequential runs may be passed 1630a to a learning model 1620a, as shown, e.g., with reference to FIG. 1, which may be used to train the learning model 1620a. The input of the learning model may also be passed 1650a to the digital twin 1610a. Similarly, the input or output of the digital twin 1610a may also be passed 1640a to the controlled space 1605a. This may happen, for example, when a digital twin produces a set of equipment control values, which are then used to run equipment, such as HVAC equipment, within the controlled space 1605a. As has been discussed, the digital twin may run iteratively to produce a solution, while the learning model may run once with each iteration.

FIG. 16B illustrates an example of a system 1600b that shows certain possible relationships between a controlled space 1605b and multiple digital twins. A controlled space 1605b may interact with multiple digital twins 1610b, 1615b, 1620b. Each digital twin may model the whole controlled space, using a different sort of digital twin. For example, a digital twin may model the building, a digital twin may model the equipment, a digital twin may model networks, and so forth. Each of these digital twins may then send information gleaned about the controlled space 1625b, 1630b, 1635b back to the controlled space, where one or more computerized controllers 305 may process the information from the digital twins 1610b, 1615b, 1620b, and determine the best way to use the information. In some embodiments, each digital twin 1610b, 1615b, 1620b is substantially similar, but models different possible future states, such as using different weather forecasts for each digital twin.

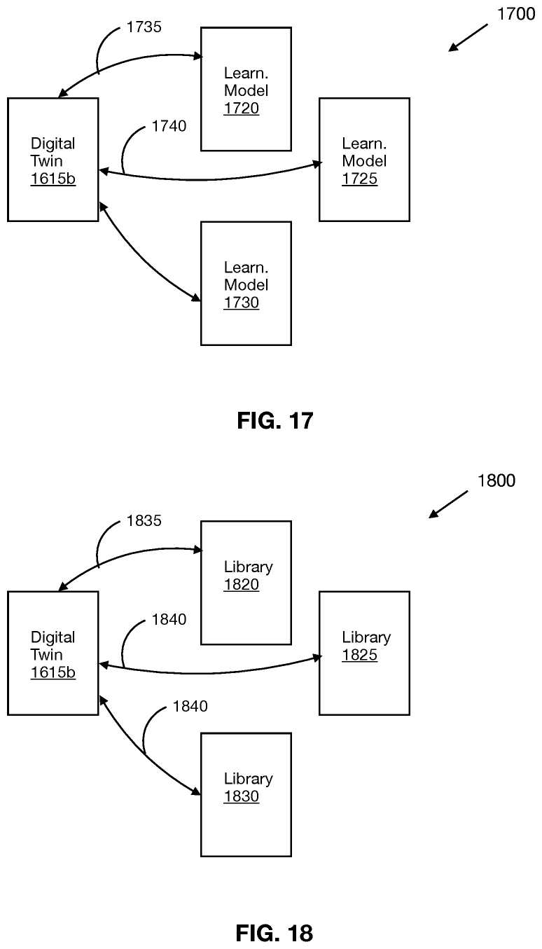

FIG. 17 discloses certain possible relationships 1700 between a digital twin 1615b and multiple learning models, e.g., 1720, 1725, and 1730. A digital twin 1615b produces training data 1730, 1735, 1740; e.g., the inputs used and the outputs generated. Each set of training data 1730, 1735, 1740 can be used to train a learning model 1720, 1725, 1730. In some embodiments, a single set of training data, e.g., 1735, may be used to train multiple learning models 1720, 1725, 1730. Multiple different learning models 1720, 1725, 1730 of different types may be trained with each set of training data. Different possible types of learning networks are discussed with reference to FIG. 4 and the surrounding text. Furthermore, a single type of learning model, such as a neural network, may be used in different configurations, that is, a different number of processing layers, a different number of nodes in the processing layers, etc. may be used in different learning models 1720, 1725, 1730. These learning models 1720, 1725, 1730 may be trained simultaneously with the training sets, as shown, or may be trained with stored libraries, as shown with reference to FIG. 18. Once trained, one or more of the learning models 1720, 1725, 1730 may be run and used to replace the digital twin, may be used to find starting inputs for the digital twin, etc.

FIG. 18 discloses certain possible relationships 1800 between a digital twin 1615b and a library of training sets 1820, 1825, 1830. The library 1820 may be stored in a computing environment 200 associated with the controlled space 1605a, 320, or elsewhere. Once training sets 1840 have been stored in a library 1820, they can be used at a later date to quickly train 1840, 1845, 1850 learning models 1825, 1830, 1835.

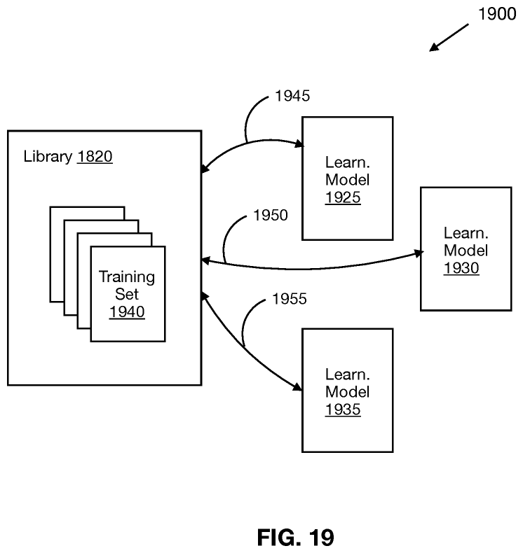

FIG. 19 discloses certain possible relationships 1900 between a library 1820 of training sets 1940 and learning models 1925, 1930, 1935. The library 1820 may be stored in a computing environment 200 associated with the controlled space 1605a, 320, or elsewhere. Once training sets 1940 have been stored in a library 1820, they can be used at a later date to quickly train 1945, 1950, 1955 learning models 1925, 1930, 1935.

It should be apparent from the foregoing description that various example embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of training a learning model using a digital twin model, the method comprising:
a learning model interfacing with the digital twin model within an iterated digital twin system:
for each iteration of the iterated digital twin system:
generating digital twin input using an optimization process;
running the digital twin model using the digital twin input, producing digital twin output;
running the learning model using the digital twin input, producing learning model output;
using the digital twin output as learning model ground truth and learning model output in a learning model cost function; and
using a cost derived from the learning model cost function to backpropagate through the learning model as a part of improving values of parameters of the learning model.

2. The method of claim 1, further comprising:
running the learning model using new input, producing learning model output;
running the digital twin model using the new input, producing digital twin output; and
comparing the learning model output and the digital twin output to determine learning model divergence from the digital twin model.

3. The method of claim 2, wherein when the learning model divergence from the digital twin model is greater than a predetermined value then performing at least one iteration of the iterated digital twin system.

4. The method of claim 3, wherein the iterated digital twin system further comprises a digital twin ground truth, and further comprising:
using the cost derived from the learning model output and the digital twin ground truth to determine when a learning model stopping state has been reached; and
when the learning model stopping state has been reached, then running the learning model without running the digital twin model.

5. The method of claim 1, wherein the learning model represents a digital twin input space more convexly than the digital twin model.

6. The method of claim 5, wherein the learning model is a recurrent neural network.

7. The method of claim 6, wherein the recurrent neural network uses a ReLu as its activation function.

8. The method of claim 7, wherein the digital twin model is a heterogenous neural network.

9. The method of claim 8, wherein the digital twin model has input nodes and output nodes, the learning model has input nodes and output nodes, and wherein there is an equal number of digital twin input nodes and learning model input nodes; and wherein there is an equal number of digital twin output nodes and learning model output nodes.

10. A learning model training system, comprising: a processor; a memory in operable communication with the processor;
a learning model interfacing with a digital twin model within an iterated digital twin system;
A digital twin input generator that generates digital twin input using an optimization process;
a digital twin model runner that runs the digital twin model using the digital twin input, producing digital twin output;
a learning model runner that runs the learning model using the digital twin input, producing learning model output;
a cost function determiner that uses the digital twin output as learning model ground truth which it compares to the learning model output producing a cost; and
a backpropagator which uses the cost to backpropagate through the learning model as a part of improving values of parameters of the learning model.

11. The system of claim 10, further comprising:
running the learning model using new input from the digital twin input generator, producing learning model output;
running the digital twin model using the new input, producing digital twin output; and
comparing the learning model output and the digital twin output to determine learning model divergence from the digital twin model.

12. The system of claim 10, further comprising an iterator, such that for each iteration, input of the digital twin model runner is used as input into the learning model.

13. The system of claim 12, wherein the digital twin model has input nodes and output nodes, the learning model has input nodes and output nodes, wherein there is an equal number of digital twin input nodes and learning model input nodes, and wherein there is an equal number of digital twin output nodes and learning model output nodes.

14. The system of claim 13, wherein the learning model represents a digital twin input space more convexly than the digital twin model.

15. The system of claim 14, wherein the iterated digital twin system further comprises a digital twin ground truth, and further comprising using the cost derived from the learning model output and the digital twin ground truth to determine when a learning model stopping state has been reached.

16. The system of claim 15, further comprising when the learning model stopping state has been reached, then running the learning model without running the digital twin model.

17. The system of claim 16, further comprising:
running the learning model using new input from the digital twin input generator, producing learning model output;
running the digital twin model using the new input, producing digital twin output; and
comparing the learning model output and the digital twin output to determine learning model divergence from the digital twin model.

18. The system of claim 17, wherein when the learning model divergence is greater than a predetermined amount, then running the learning model within the iterated digital twin system.

19. A non-transient storage medium configured with code which upon execution by one or more processors contains instructions for performing a method of training a learning model using a digital twin model, method comprising: for each iteration of an iterated digital twin system:
generating digital twin input using an optimization process;
running the digital twin model using the digital twin input, producing digital twin output;
running the learning model using the digital twin input, producing learning model output;
using the digital twin output as learning model ground truth and learning model output in a learning model cost function; and
using a cost derived from the learning model cost function to backpropagate through the learning model as a part of improving values of parameters of the learning model.

20. The non-transient storage medium of claim 19, the method further comprising:
running the learning model using new input, producing learning model output;
running the digital twin model using the new input, producing digital twin output; and
comparing the learning model output and the digital twin output to determine learning model divergence from the digital twin model.
